(19) United States
(12) Patent Application Publication
(10) Pub. No.: US 2008/0110061 A1
(43) Pub. Date: May 15, 2008

(54) Novelty footwear item with flask

(75) Inventor: Brett D. Ritter, Del Mar, CA (US)

Correspondence Address: JERRY RICHARD POTTS, 3248 VIA RIBERA, ESCONDIDO, CA, 92029, US

(73) Assignee: South Cone, Inc. dba REEF, San Diego, CA (US)

(21) Appl. No.: 11/595,213

(22) Filed: Nov. 11, 2006

(51) Int. Cl. A43B 23/24; A43B 13/00; A43B 21/36; B67D 5/64

(52) U.S. Cl. 36/136; 36/25 R; 36/42; 222/175

(57) ABSTRACT

A novelty footwear construction includes a cassette-like heel component which is sandwiched between a mid-sole and an outsole for supporting the heel of a user, and wherein the heel component includes an upper retainer, a lower retainer, and a hollow flask for supporting the heel of a user and for providing the user with a source of fluid refreshment.

### FIELD OF THE INVENTION

This invention relates generally to novelty items and more particularly to a novelty footwear item which includes a heel construction flask for reinforcing heel support and for providing a user with a source of liquid refreshments as needed.

### BACKGROUND OF THE INVENTION

A new and improved novelty footwear construction includes a base outsole, a top mid-sole, and a unique and novel reinforced heel construction having a hollow chamber with a plurality of curved shaped reinforcement ribs disposed throughout its structure and a combination inlet/outlet that permits a user to fill the hollow chamber with liquid refreshments and then drinks as desired without significantly changing the heel support provided by the footwear.

### SUMMARY OF THE INVENTION

A new and improved novelty footwear construction includes a cassette-like heel component which is sandwiched between a mid-sole and an outsole for supporting the heel of a user, and wherein the cassette-like heel component includes an upper retainer and a lower retainer for positioning and helping to secure in place within the heel support area a hollow flask which provides the user with a source of fluid refreshment.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings wherein:

FIG. 1 is a pictorial view of a novelty footwear item, which is constructed in accordance with the present invention;

FIG. 1A is a side elevational view of another novelty footwear item, which is constructed in accordance with the present invention.

FIG. 20 is an exploded view of the novelty footwear item of FIG. 1;

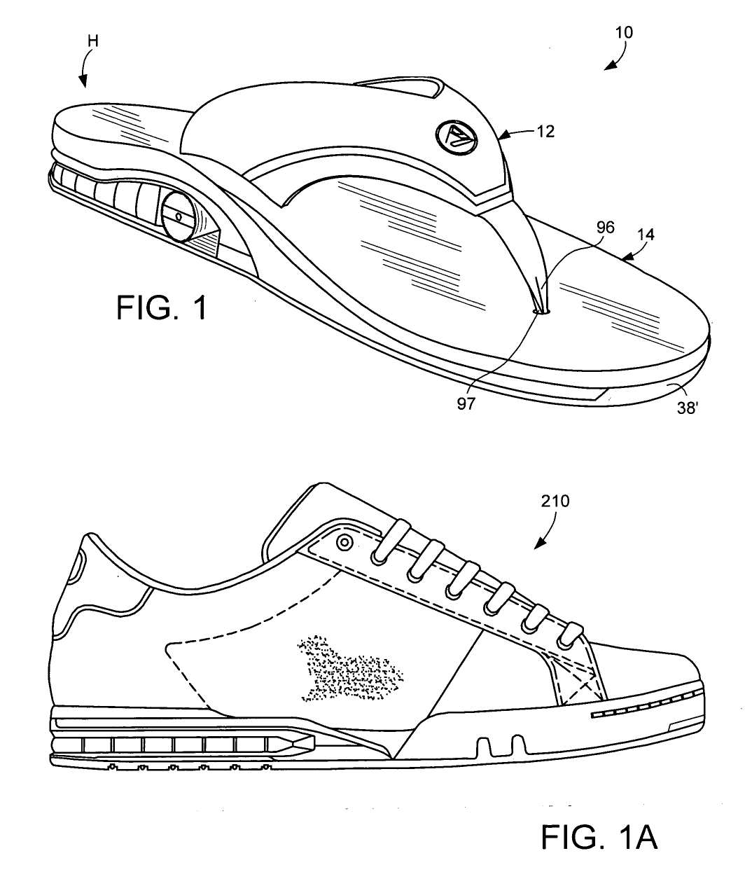

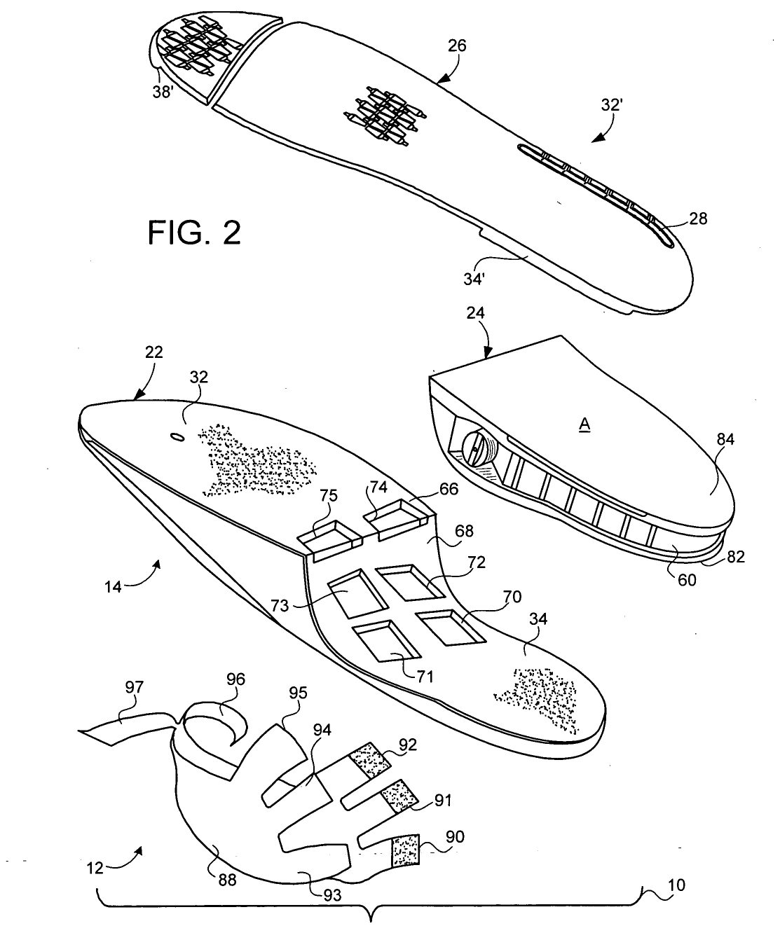

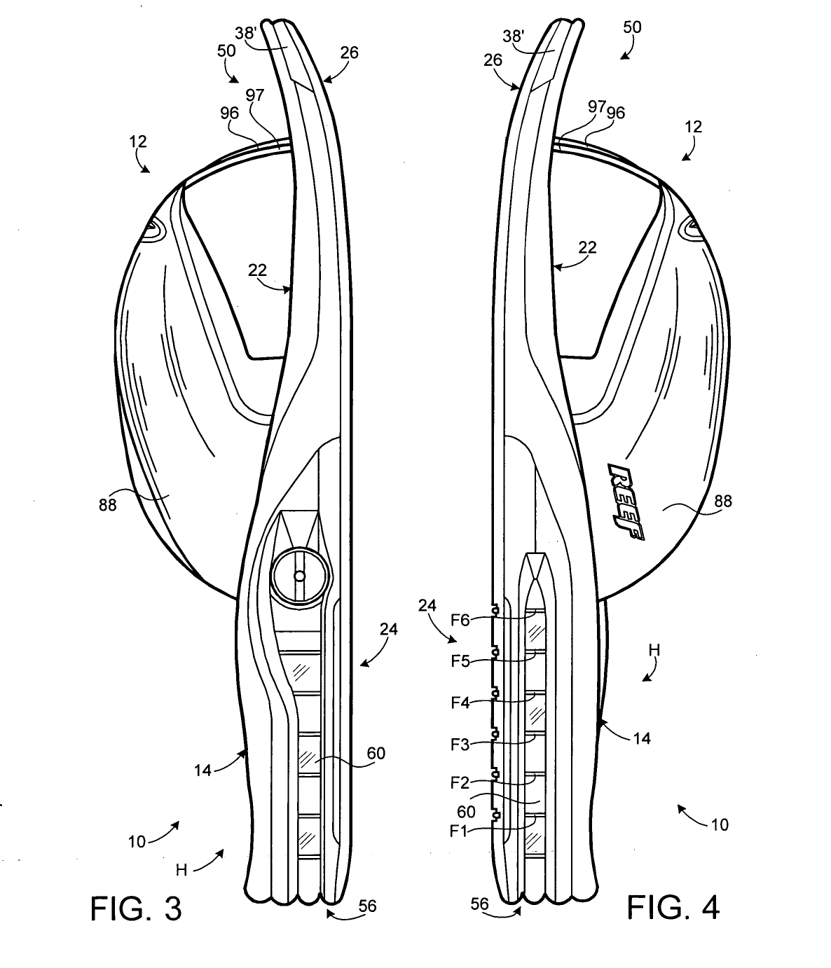

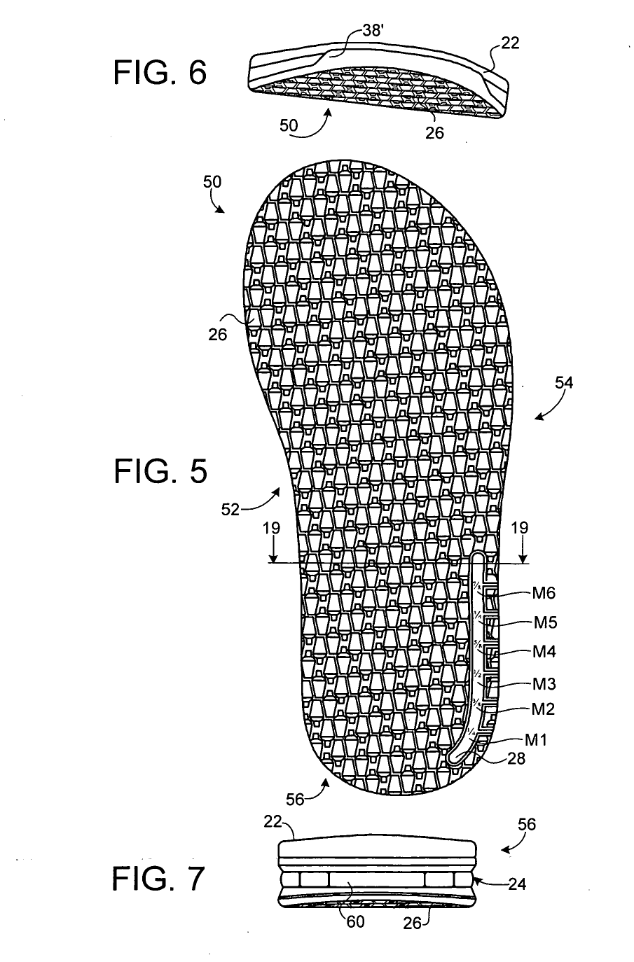

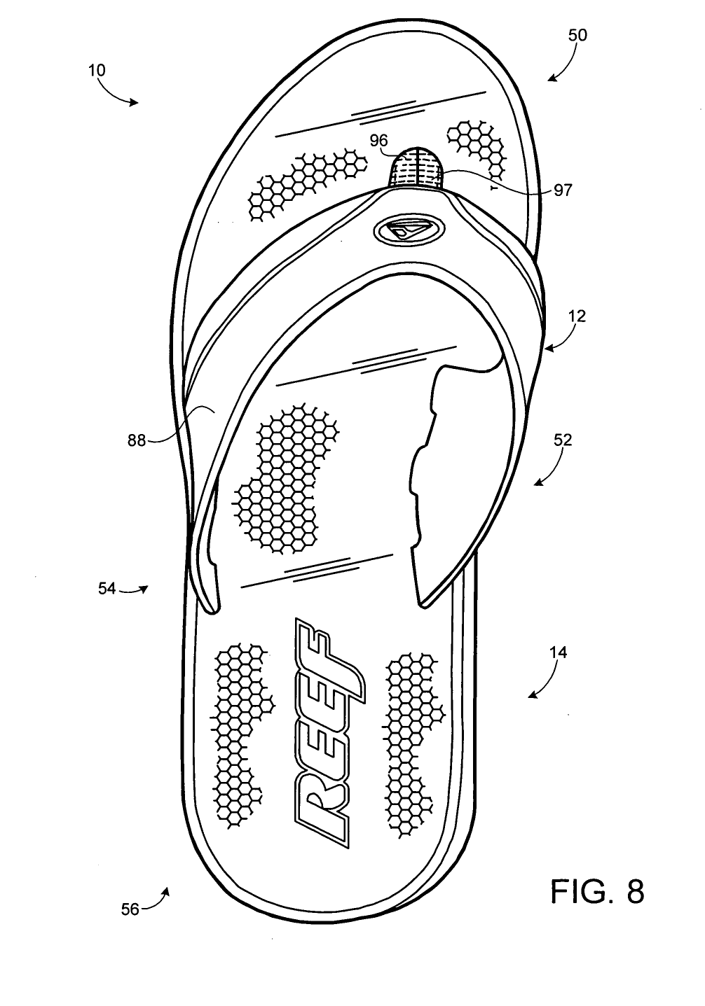

FIG. 3 is a right-side elevational view of the novelty footwear item of FIG. 1;

FIG. 4 is a left-side elevational view of the novelty footwear item of FIG. 1;

FIG. 5 is a bottom plane view of a portion of the novelty footwear item of FIG. 1;

FIG. 6 is a front elevational view of the novelty footwear item of FIG. 1, with its foot support strap removed;

FIG. 7 is a rear elevational view of the novelty footwear item as illustrated in FIG. 1, with its foot support strap removed;

FIG. 8 is a top plane view of the novelty footwear item of FIG. 2;

FIG. 9 is a top plane view of a retainer forming part of the heel component as illustrated in FIG. 2;

FIG. 10 is a top plane view of another retainer forming part of the heel component as illustrated in FIG. 2;

FIG. 11 is a top plane view of a flask forming part of the heel component as illustrated in FIG. 2;

FIG. 12 is a bottom plane view of the flask forming part of the heel component as illustrated in FIG. 2;

FIG. 13 is a sectional view of the flask as illustrated in FIG. 11;

FIG. 14 is a left-side elevational view of the flask of FIG. 12;

FIG. 15 is a sectional view of the spigot and knob of the flask as illustrated in FIG. 14, taken substantially along the line 15-15;

FIG. 16 is a sectional view taken substantially along the line 16-16 of the spigot and knob of the flask forming part of the heel component as illustrated in FIG. 15;

FIG. 17 is a sectional view taken substantially along the line 17-17 of the spigot and knob of the flask forming part of the heel component as illustrated in FIG. 15;

FIG. 18 is a side elevational view of the spigot and knob of the flask forming part of the heel component as illustrated in FIG. 15;

FIG. 19 is a sectional view of the footwear item as illustrated in FIG. 5, taken substantially along line 19-19;

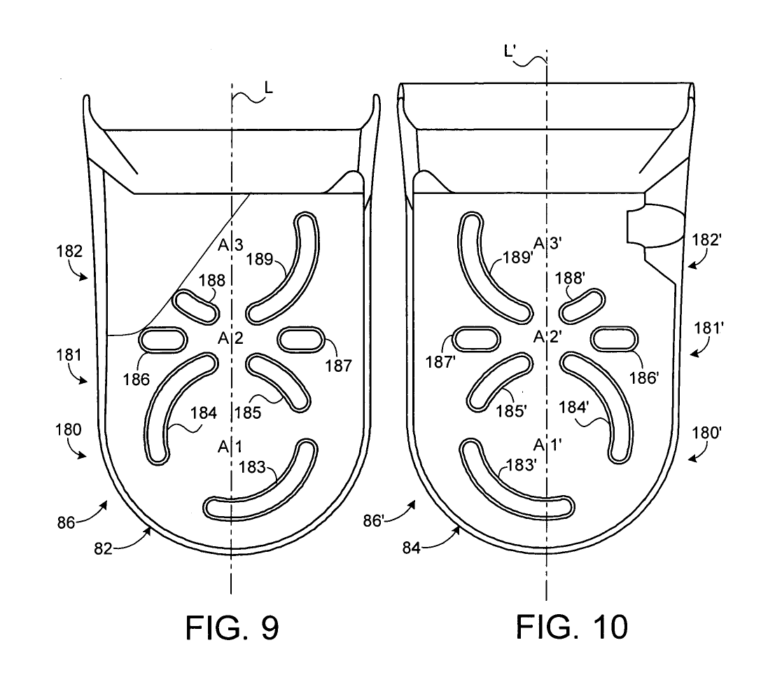

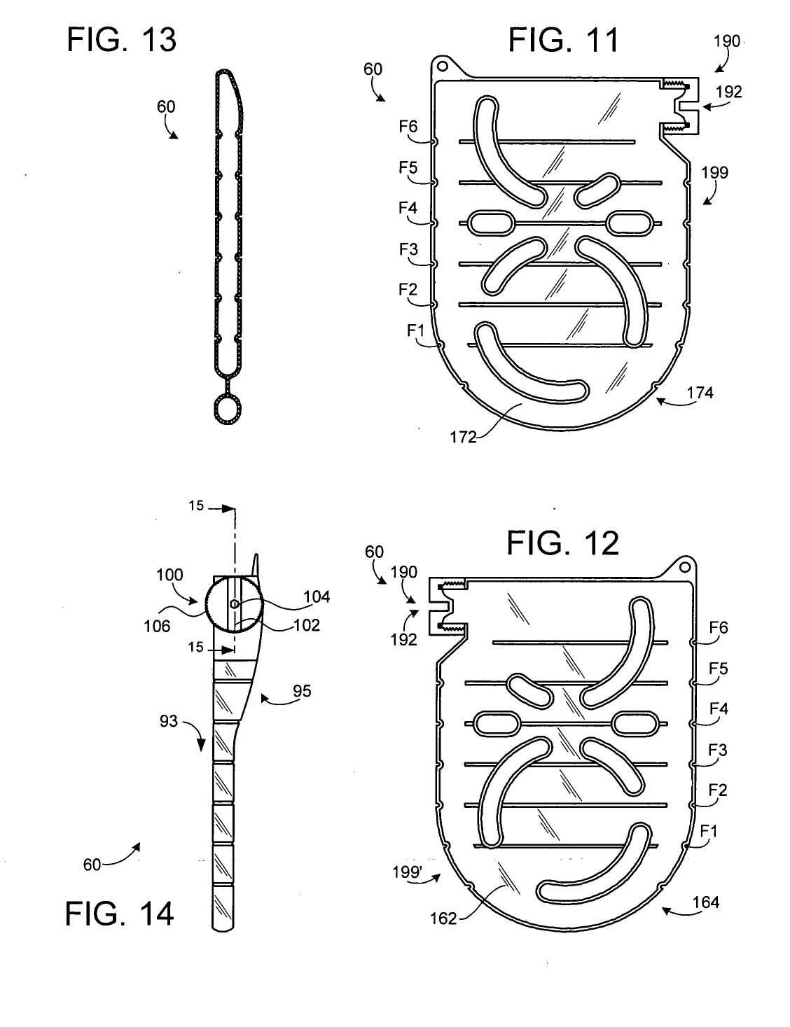

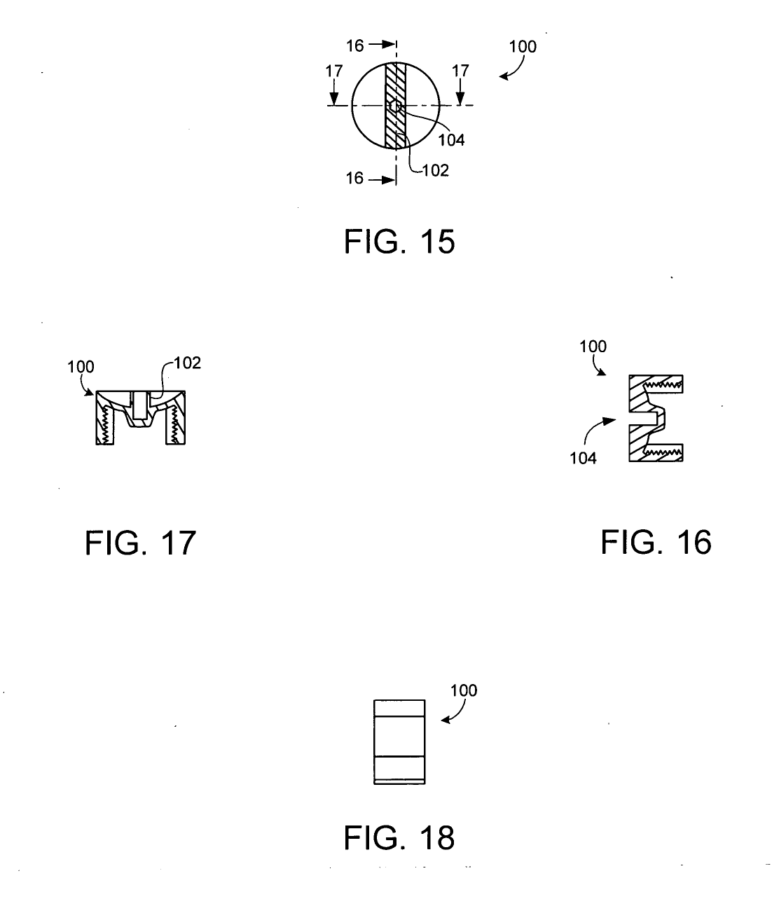

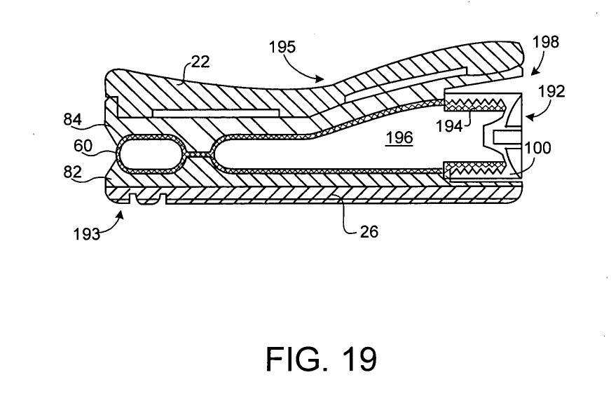

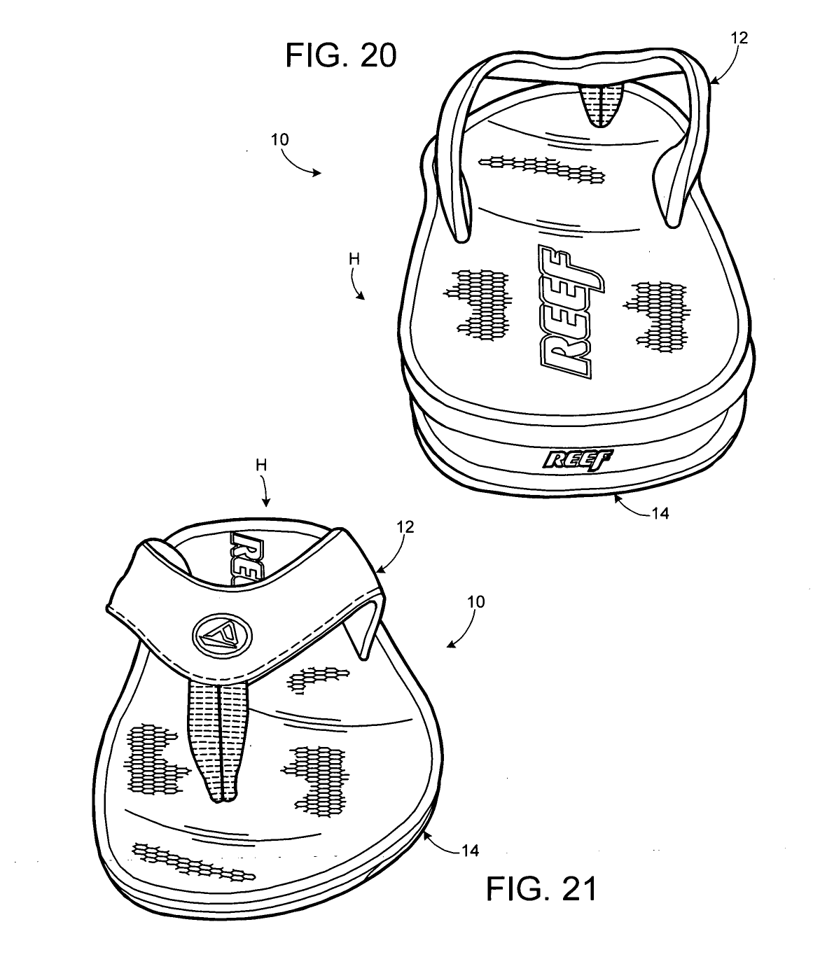

FIG. 20 is a rear pictorial view of the novelty footwear item of FIG. 1; and

FIG. 21 is a front pictorial view of the novelty footwear item of FIG. 1.

### DETAILED DESCRIPTION OF THE PREFERRED EMBODIMENTS OF THE INVENTION

Referring now to the drawings and more particularly to FIGS. 1 and 2 there is shown an illustrative preferred embodiment of a novelty footwear item 10, which is constructed in accordance with the present invention. The novelty footwear item 10 when used in accordance with a novel method of using the footwear item 10, not only protects and supports the foot of a user with an attractive fashion wear appearance but also provides a novelty footwear item which enables a user (not shown) to easily and conveniently access a source of refreshing liquid stored within the footwear 10.

Considering now the novelty footwear item 10 in greater detail with reference to FIGS. 1 and 2, the novelty footwear item 10 generally comprises an upper or foot strap assembly 12 and a bottom or foot-shaped sole assembly 14 which is held to the foot of the user by the foot strap assembly 12. The upper 12 and the bottom 14 in combination, provide the foot of the user with an attractive fashion wear appearance.

Considering now the top strap assembly 12 in greater detail with reference to FIGS. 1-4, the strap assembly 12 has a unitary construction which generally includes a foot or main body strap 88 having a plurality of integrally connected rear anchor or anchoring straps 90-95 and a plurality of integrally connected front anchor or anchoring straps 96-97. The rear and front anchoring straps 90-95 and 96-97 respectively, are flexible narrow fingers which extend outwardly from the main body strap 88, and are all configured to be adhesively secured to the sole assembly 14 as will be explained hereinafter in greater detail. The foot strap assembly 12 is composed of a soft pliable material, which is configured to hold the foot of the user to the sole assembly 14 to facilitate protecting and supporting the foot of the user.

Considering now the bottom or sole assembly 14 in greater detail with reference to FIGS. 1-4, the sole assembly 14 generally includes an outer sole 26 for providing the footwear item with good ground traction, a foot-platform or mid-sole 22 for supporting the underside of the foot of a user, and a cassette-like heel component or flask assembly 24 for cushioning the heel of the user and for providing the user with the source of liquid refreshment.

As best seen in FIGS. 2-4, the flask assembly 24, is sandwiched between the mid-sole 22 and the outer sole 26 at about a heel portion (indicated generally at H) of the novelty footwear item 10. In this regard, the mid-sole 22, the outer sole 26, the heel assembly 24 and the strap assembly 12, cooperates with one another to not only support and protect the foot of the user, but also provides the user, as previously explained, with a predetermined supply of liquid refreshment which can be easily and conveniently accessed by the user as needed.

The bottom assembly 14 in top plane view as best seen in FIG. 8, has a sufficient surface area to support the bottom surface of a human foot. The bottom assembly 14 functions to protect, cushion and support the foot of the user. When assembled, the bottom assembly 14 is lightweight and is configured in an attractive fashion wear ornamental design. In this regard, as best seen in FIGS. 7-8, the bottom assembly 14 further includes a front or forefoot section indicated generally at 50, a medial side indicated generally at 52, a lateral side indicated generally at 54, and a rear or heel section indicated generally at 56.

Considering now the flask assembly 24 in greater detail with reference to FIG. 2, the heel component or flask assembly 24 has a cassette-like structure which includes a novelty item in the form of a graduated flask 60, which is sandwiched between a pair of retainers, which includes a top retainer 82 and a bottom retainer 84. The flask 60 has a sufficient volume to hold a predetermined amount of liquid refreshment, such as water, for easy access by the user.

As best seen in FIG. 4, the flask 60, is transparent and includes a series of liquid level marks or score lines that provide the user with a visual indication of the amount of fluid remaining in the flask 60. Although in the preferred embodiment of the present invention the flask 60 is described as being transparent to allow a user to see the amount of liquid stored in the flask 60, it is contemplated that the flask 60 may also be opaque.

Considering now the top mid-sole 22 in greater detail with reference to FIGS. 1-4, the mid-sole 22 has a foot-platform configuration dimensioned to receive thereon the under foot of a user. The mid-sole 22 is composed of soft cushioning like material, such as ethylene vinyl acetate (EVA), which provides a stable and easily tolerated platform for supporting and cushioning the foot of the user. As will be explained hereinafter in greater detail, the mid-sole 22 is constructed to engage and to be secured adhesively to the strap assembly 12, which in the combination with the bottom outsole 26 and the flask assembly 24, function to not only support the foot of the user in a comfortable secure manner, but also functions to help hold the foot of the user in engagement with the foot-platform provided by the upper mid-sole 22.

While the mid-sole 22 has been describes as being composed of ethylene vinyl acetate (EVA) is should be understood by those skilled in the art, that the mid-sole 12 may be composed of a wide variety of flexible materials, such as thermoplastic, thermosetting polymer compounds, foam polyurethane plastic or foam rubber. Ethylene vinyl acetate (EVA) is a preferred material because of its hardness and density which provides the user with a relatively soft cushioning like platform that facilitates foot comfort.

Considering now the bottom or outer sole 26 in greater detail with reference to FIGS. 2 and 5, the outer sole 26 is also shaped in a foot-like engagement platform configuration and is dimensioned to adhesively engage and substantially cover a smooth planar like bottom surface area A of the flask assembly 24 and a front-portion of the mid-sole 22, indicated generally at 32. In this regard, as will be explained hereinafter in greater detail, once the strap assembly 14 is secured adhesively to the upper mid-sole 22, the cassette-like flask assembly 24 is then adhesively secured to a rear portion of the mid-sole 22, indicated generally at 34, to form a substantially flat platform area from the rear to a mid-foot area of the sole assembly 14. This flat platform area is dimensioned to conform to the shape of outer sole 26, and more particularly to correspond to the shape of the inner surface of the outer sole 26.

Considering now the outer sole 26 in still greater detail with reference to FIGS. 2 and 5, the outer sole 26 is composed of a wide variety of flexible materials, such as rubber compounds, thermoplastic, thermosetting polymer compounds, foam polyurethane plastic, foam rubber and ethylene vinyl acetate. A rubber compound is a preferred material, which is sufficiently durable to function over an extended period of time as a wear surface for engaging the ground and providing the footwear 10 with the ability to grip and maintain traction with the ground.

Also since the bottom surface of the outer sole 26 is highly visible, the bottom surface of the outer sole 26, as best seen in FIG. 5, bears a unique non-skid stylized pattern which functions to prevent the footwear item 10 from slipping on the ground, to provide the footwear item 10 with traction and to provide the outer sole 26 with an attractive appearance. As will be explained hereinafter in greater detail, the outer sole 26 also functions for facilitating transferring the dynamic energy imparted by the user to the footwear item 10 into controlled motion in a user desired and selected direction.

In order to assist the user in determining the amount of liquid refreshment or fluid remaining in the flask 60, the bottom of the outer sole 26 includes an integrally formed gauge 28 as best seen in FIG. 5. The gauge 28, includes a plurality of visible markers M1 to M6 respectively, where each individual marker, such as the marker MI is configured in a specific liquid level indicating indicia-like arrangement. Table I illustrates the level indicia for each one of the markers M1-M6. As best seen in FIG. 5, the individual marker M1-M6 respectively, are aligned with the gradient indicators F1-F6 respectively, which are disposed on the flask 60.

TABLE I

| | Markers M | | | | | |
|---|---|---|---|---|---|---|
| | Marker | Marker | Marker | Marker | Marker | Marker |
| | MI | M2 | M3 | M4 | M5 | M6 |
| Indicators F | ¼ | ⅜ | ½ | ⅜ | ¾ | ⅞ |

Although in the preferred embodiment of the present invention the gauge is described as being molded into the bottom outsole 26, it will be understood by those skilled in the art that a gauge slot could be provided in the bottom outsole 26 so the gauge could be glued into the slot as a separate part. Therefore there is no intention of limiting the scope of the present invention to an integrally formed gauge.

Considering now the flask assembly 24 in greater detail with reference to FIGS. 9-18, as mentioned earlier, the flask assembly 24 generally includes the flask 60, the upper flask retainer 82, and the lower flask retainer 84, which retainers 82, 84 are configured to retain and hold therebetween the flask 60. In order to facilitate retaining the flask 60 between the retainers 82 and 84 respectively, each individual flask retainer, such as the flask retainer 82, includes a series of ribs or boss members indicated generally at 86. The ribs 86 of the flask retainer 82 are in a mirror image arrangement relative to the ribs or boss members (indicated generally at 86′) of the flask retainer 84. As will be explained hereinafter in greater detail, the ribs 86 and 86′ allow the transfer of the weight of the user from the top of the novelty footwear 10, to the bottom of the novelty footwear 10 without placing unwanted or undesired stress on the flask 60. This is an important feature of the novelty footwear 10 as it assures the flask 60, when empty of fluid, will not collapse or compress under the weight of the user, even when the user rock onto his or her heels to place a maximum load on the flask 60.

Considering now the flask 60 in still greater detail with reference to FIGS. 11-14, the flask 60 is a hollow member having a maximum fluid retaining capacity of about four liquid ounces. The flask 60 has a bottom side, indicated generally at 162, and a top side, indicated generally at 172. Each side of the flask 60, includes a series of deep recesses or indents, indicated generally at 164 and 174 respectively. The recesses 164 and 174 are arranged as the mirror image of one another and correspond in their physical layouts to the layout of the ribs 86 and 86′ respectively. This is another important feature of the novelty footwear 10 as the recesses 164 and 174 form a series of walls within the flask 60 that facilitate maximum fluid holding capacity while providing maximum heel support for the user regardless of whether the flask 60 is full or empty of fluid content. The recesses 164 and 174 also act as stops within the hollow interior of the flask 60 to effectively stop the fluid within the flask 60 from being captured. In short, when the novelty footwear 10 is held in the hand of the user for the purpose of emptying the flask 60 of its fluid content, the recesses cooperate to form a plurality of curved maze-like channels that provide a heel support network between a portion of the bottom outsole 26 and a portion of the top mid-sole 22. The maze-like channels also cooperate to assure no fluid entrapment within the interior of the flask 60.

As best seen in FIGS. 11-12 and 19, the flask 60 includes an fluid entrance or exit end, indicated generally at 190, which includes a large exit aperture or hole 192, which is defined by a threaded hollow boss member 194 having a generally cylindrical shape. A sealing cap 100, is threadably received on the boss member 194 to provide a liquid tight seal for the flask 60.

The boss member 194 as best seen in FIG. 19, is set back within a cutout area, indicated generally at 198. In this regard, the cap 100, when disposed on the flask 60, is setback within the heel portion H of the footwear 10, so that its outer face is flush with the periphery boundary of the medial side 52 of the footwear 10. This is another important feature of the novelty footwear 10 as it assure the cap 100 will not accidentally come into contact with unwanted and undesired objects in close proximity to the medial side of the footwear 10.

It should also be understood by those skilled in the art, that the large exit hole 192 is also an important feature of the novelty footwear 10. More specifically, the presence of the large exit hole 192 allows: 1) the flask 60 to be easily filled with liquid and 2) helps avoid fluid entrapment within the flask 60 as it is being emptied. As best seen in FIG. 19, it should also be understood, that the large exit hole 192 cooperates with the physical structure of the flask 60 to facilitate filling and emptying the flask 60. That is, the flask structure is flat over a substantial first or flat portion 193 of the exit end 190, thereby avoiding fluid entrapment. This flat configuration or first portion 193, abruptly transitions into a large exit cavity, indicated generally at 196, over a substantial second portion 195 of the exit end 190. This allows fluid to flow freely into and out of the flask 60 as desired.

Considering now the cap 100 in greater detail with reference to FIGS. 15-19, the cap 100, is configured to be threadably received onto the threaded boss 194 in a fluid tight manner. The cap 100 includes a centrally disposed raised boss or finger gripping member 102 that has a centrally disposed recess 104. The recess 104 is configured to receive therein a fin key. The cap 100 also includes an outer surface, indicated generally at 106, having a series of micro hills and valleys, which facilitate finger gripping by the user. From the foregoing, it should be understood by those skilled in the art, that the cap 100 may be removed by 1) the user gripping the raised boss 102 to facilitate turning the cap 100 for cap removal purposes; 2) the user gripping the outer surface 106 to facilitate turning the cap 100 for cap removal purposes; or 3) inserting and capturing a fin key within the recess 104, allowing the user to turn the fin key for turning the cap 100 for cap removal purposes.

As noted earlier, the ribs of the retainers 82 and 84 respectively, correspond in shape, size and layout to the respective recess areas of the flask 60. More specifically, the rib area of retainer 82, indicated generally at 86, corresponds to the recesses 199′, while the rib area of retainer 84, generally indicated at 86′, correspond in shape and location to the recesses 199. This is an important feature of the novel footwear 10 because it allows the flask 60 to be sandwiched between the retainers 82 and 84 respectively to provide a cassette-like structure that transfers weight loads, prevents the flask 60 from being crushed under such weight loads and provides the user with a firm heel support that is free of any indication an unpleasant tactile sensation created by the ribs and recesses. More particularly, since the outer surfaces of the retainers 82 and 84 are smooth planar like surfaces, they are seamless surfaces to the user, helping to provide the heel of the user with a smooth flat sturdy heel support platform.

Considering now the rib area 86 of retainer 82 in greater detail with reference to FIG. 9, the rib area 86 generally includes a set of three ribs configuration areas: a first rib configuration area 180, a second rib configuration area 181, and a third rib configuration area 182.

Considering now the first rib configuration area 180 in greater detail with reference to FIG. 9, the first rib configuration area generally includes a pair of long semi-circular-like segments 183 and 184 respectively, and a short semi-circular-like segment 185. The three semi-circular-like segments 183-185 are arranged in a generally circular pattern, slightly spaced apart from one another. In this arrangement the inside area bounded by the segments 183-185 forms a rear recess area, indicated generally at A1.

Considering now the second rib configuration area 181 in greater detail with reference to FIG. 9, the second rib configuration area 181 generally includes a pair of spaced apart short straight segments 186 and 187 respectively. The two short straight segments 186-187 are aligned with one another along the width dimension of the retainer 82 and slightly spaced from segments 184 and 185 respectively in the first rib configuration area 180. As will be explained hereinafter in greater detail, the short rib segments 186-187 in cooperation with the rib segments 184-185 help for a central recess area, indicated generally at A2.

Considering now the third rib configuration area 183 in greater detail with reference to FIG. 9, the third rib configuration area 182 generally includes a pair of spaced circular segments: a short circular segments 188 and a long circular segment 189. Relative to an imaginary longitudinal line, indicated generally at L, the circular segment 188 is in parallel alignment with segment 184, while circular segment 189 is in parallel alignment with segments 183 and 185 respectively. The third rib configuration area 182 cooperates with the ribs in the first and second rib configuration areas 180 and 181 respectively, to help form the central recess area, indicated generally at B. Also the circular segments 188 and 189 cooperate with a front wall W of the retainer 82 to form a front recess area, indicated generally at A3.

As the rib configurations of retainer 84 are the mirror image of the rib configurations of retainer 82, they will not be described hereinafter in greater detail, except to mention that they are identified with the same reference characters as associated with retainer 82, but with primes added to distinguish them from the ribs of retainer 82.

Considering now the outer sole 26 in still greater detail with reference to FIGS. 2-4, the outer sole 26 includes a set of retaining or alignment tabs which help position, and retain the outer sole 26, in proper alignment with the mid sole 22 and the flask assembly 24. In this regard, the outer sole 26 includes a front tab 38′, a medial side tab 32′, and a lateral side tab 34′.

As best seen in FIG. 6, the front tab 32 is configured to fit within a front cutout provided in the mid-sole 22. In a similar manner the medial side tab 32′ and the lateral side tab 34′ are configured to fit within side cutouts provided in the bottom retainer 84 of the flask assembly 24.

It is evident that there are additional embodiments and applications of the new and improved novelty footwear item which are not disclosed in this detailed description, but which would clearly fall with the scope of said invention. For example, although in the preferred embodiment of the present invention, the foot strap 12 is described as having a plurality of integrally connected front anchoring straps, such as the anchoring straps 96-97, it will be understood by those skilled in the art, that the anchoring strap may comprise a single strap, as opposed to a pair of front anchoring straps. In a similar manner although the footwear 10 is illustrated as a sandal, it will be understood by those skilled in the art that other types and kinds of footwear could also be utilized to include such a novelty flask item. For example, the novelty footwear could be configured in the form of a shoe, such as the shoe 210 as illustrated in FIG. 1A instead of a sandal. Based on the foregoing, this specification is intended therefore to illustrate and clarify the nature of this invention and not limit its scope.

I claim:

1. A novelty footwear construction, comprising:
a bottom outsole;
a top mid-sole; and
a heel support structure, said heel support structure including a hollow chamber sub-divided by a plurality of curved maze-like channels for providing a heel support network between a portion of said bottom outsole and a portion of said top mid-sole.

2. The novelty footwear construction according to claim 1, wherein said hollow chamber is further subdivided by at least a pair of straight leg channels disposed individually between pairs of curved maze-like channels for further providing said heel support network between said portion of said bottom outsole and said portion of said top mid-sole.

3. The novelty footwear construction according to claim 2, wherein said hollow chamber is resilient and flexible to provide the heel of a user with comfortable support.

4. The novelty footwear construction according to claim 3, wherein said plurality of curved maze-like channels and said straight leg channels cooperate to help define a path from one end of said hollow chamber to another end of said hollow chamber.

5. The novelty footwear construction according to claim 4, wherein the one end of said hollow chamber is a combination inlet/outlet for the ingress and egress of liquid of a sufficient volume to fill said hollow chamber.

6. The novelty footwear construction according to claim 5, wherein said curved maze-like channels and said straight leg channels are barriers.

7. The novelty footwear construction according to claim 6, wherein said hollow chamber has an outer boundary and wherein said curved maze-like channels are curved inwardly away from said outer boundary.

8. The novelty footwear construction according to claim 7, wherein said hollow chamber has an upper surface and a lower surface, wherein said upper surface in non-planar and wherein said lower surface is planar.

9. The novelty footwear construction according to claim 8, wherein said upper surface is raised at about said combination inlet/outlet to provide arch support for the foot of the user.

10. A novelty footwear construction, comprising:
a cassette-like heel component sandwiched between a mid-sole and an outsole, wherein said heel component includes an upper retainer, a lower retainer, and a hollow flask.

11. A novelty footwear construction according to claim 10, wherein said hollow flask is a partitioned flask having no stop points for preventing the free flow of fluids within said flask to and from a fluid access point.

12. A novelty footwear construction according to claim 11, wherein said partitioned flask includes at least one set of spaced apart curved partitions for helping to define a generally circular central heel support area at a rear portion of said flask.

13. The novelty footwear construction according to claim 12, wherein said partitioned flask includes at least another set of spaced apart curved partitions.

14. The novelty footwear construction according to claim 13, wherein said at least one set of spaced apart curved partitions and said at least another set of spaced apart curved partitions are spaced from one another by a set of straight leg partitions.

15. The novelty footwear construction according to claim 14, wherein a front portion of said flask slopes upwardly and away from said another set of spaced apart curved partitions for forming an arch; and
wherein said arch terminates at a threaded spigot defining said fluid access point.

16. The novelty footwear construction according to claim 15, wherein said one set of spaced apart curved partitions and said at least another set of spaced apart curved partitions are disposed at locations within said flask to provide a balance between maximum fluid storage capacity and maximum heel support.

17. The novelty footwear construction according to claim 16, wherein said flask has a periphery; and wherein said one set of spaced apart curved partitions and said at least another set of spaced apart curved partitions are disposed at about said periphery for providing said periphery with sufficient support to substantially prevent edge collapse under the weight of a user.

18. A novelty item, comprising:
a fluid dispensing flask having a dispensing portion in a generally rectangular shape and a heel support portion in a generally semi-circular shape;
said flask having a series of spaced apart volume marking for providing a visual indication of the quantity of fluid disposed within said flask;
said flask being sandwiched between an upper retaining member and a lower retaining member for forming a heel component; and
wherein said heel component is sandwiched between an upper mid-sole and an outer sole for helping to define a footwear member.

19. The novelty item according to claim 18, wherein said outer sole includes a gradient for providing a user with an indication of a remaining fluid volume within said flask.

20. The novelty item according to claim 19 wherein said gradient has a series of spaced apart gradient markings; and
wherein said gradient markings are disposed in alignment with said series of spaced apart volume markings.
